(19) United States
(12) Patent Application Publication
(10) Pub. No.: US 2016/0020898 A1
(43) Pub. Date: Jan. 21, 2016

(54) PRIVACY-PRESERVING RIDGE REGRESSION

(71) Applicants: Valeria NIKOLAENKO, (US); Udi WEINSBERG, (US); Stratis IOANNIDIS, (US); Marc JOYE, (US); Nina TAFT, (US)

(72) Inventors: VALERIA NIKOLAENKO, STANFORD, CA (US); UDI WEINSBERG, MENLO PARK, CA (US); STRATIS IOANNIDIS, SAN FRANCISCO, CA (US); MARC JOYE, FOUGERES (FR); NINA TAFT, SAN FRANCISCO, CA (US)

(21) Appl. No.: 14/771,771

(22) PCT Filed: Sep. 25, 2013
(86) PCT No.: PCT/US13/61690

§ 371 Date: Aug. 31, 2015

Related U.S. Application Data
(60) Provisional application No. 61/772,404, filed on Mar. 4, 2013.

(51) Int. Cl. H04L 9/00; H04L 29/06

(52) U.S. Cl. CPC H04L 9/008; H04L 63/0428; H04L 2209/24

(57) ABSTRACT

A hybrid approach to privacy-preserving ridge regression is presented that uses both homomorphic encryption and Yao garbled circuits. Users in the system submit their data encrypted under a linearly homomorphic encryption. The linear homomorphism is used to carry out the first phase of the algorithm that requires only linear operations. The output of this phase generates encrypted data, in a form that is independent of the number of users n. In a second phase, a Yao garbled circuit that first implements homomorphic decryption and then does the rest of the regression algorithm (as shown, an optimized realization can avoid decryption in the garbled circuit) is evaluated. For this step a Yao garbled circuit approach is much faster than current fully homomorphic encryption schemes. Thus the best of both worlds is obtained by using linear homomorphisms to handle a large data set and using garbled circuits for the heavy non-linear part of the computation.

### REFERENCE TO RELATED APPLICATIONS

This application claims the benefit of U.S. Provisional Application Ser. No. 61/772,404 filed Mar. 4, 2013 which is incorporated by reference herein in its entirety.

This application is also related to the applications entitled: “PRIVACY-PRESERVING RIDGE REGRESSION USING MASKS”, and “PRIVACY-PRESERVING RIDGE REGRESSION USING PARTIALLY HOMOMORPHIC ENCRYPTION AND MASKS” which have been filed concurrently and are incorporated by reference herein in their entirety.

### BACKGROUND

1. Technical Field

The present invention generally relates to data mining and more specifically to protecting privacy during data mining using ridge regression.

2. Description of Related Art

Recommendation systems operate by collecting the preferences and ratings of many users for different items and running a learning algorithm on the data. The learning algorithm generates a model that can be used to predict how a new user will rate certain items. In particular, given the ratings that a user provides on certain items, the model can predict how that user will rate other items. There is a vast array of algorithms for generating such predictive models and many are actively used at large sites like Amazon and Netflix. Learning algorithms are also used on large medical databases, financial data, and many other domains.

In current implementations, the learning algorithm must see all user data in the clear in order to build the predictive model. In this disclosure it is determined whether the learning algorithm can operate without the data in the clear, thereby allowing users to retain control of their data. For medical data this allows for a model to be built without affecting user privacy. For books and movie preferences letting users keep control of their data reduces the risk of future unexpected embarrassment in case of a data breach at the service provider. Roughly speaking, there are three existing approaches to data-mining private user data. The first lets users split their data among multiple servers using secret sharing. These servers then run the learning algorithm using a distributed protocol and privacy is assured as long as a majority of servers do not collude. The second is based on fully homomorphic encryption where the learning algorithm is executed over encrypted data and a trusted third party is trusted to only decrypt the final encrypted model. In a third approach Yao's garbled circuit construction could be used to compute on encrypted data and obtain a final model without learning anything else about user data. However an approach based upon Yao has never been applied to the regression class of algorithms before.

### SUMMARY

A hybrid approach to privacy-preserving ridge regression is presented that uses both homomorphic encryption and Yao garbled circuits. Users in the system submit their data encrypted under a linearly homomorphic encryption system such as Paillier or Regev. The Evaluator uses the linear homomorphism to carry out the first phase of the algorithm that requires only linear operations. This phase generates encrypted data. In this first phase, the system is asked to process a large number of records (proportional to the number of users in the system n). The processing in this first phase prepares the data such that the second phase of the algorithm is independent of n. In a second phase, the Evaluator evaluates a Yao garbled circuit that first implements homomorphic decryption and then does the rest of the regression algorithm (as shown, an optimized realization can avoid decryption in the garbled circuit). This step of the regression algorithm requires a fast linear system solver and is highly non-linear. For this step a Yao garbled circuit approach is much faster than current fully homomorphic encryption schemes. Thus the best of both worlds is obtained by using linear homomorphisms to handle a large data set and using garbled circuits for the heavy non-linear part of the computation. The second phase is also independent of n because of the way the computation is split into two phases.

In one embodiment method for privacy-preserving ridge regression is provided. The method includes the steps of requesting a garbled circuit from a crypto service provider; collecting data from multiple users that has been formatted and encrypted using homomorphic encryption; summing the data that has been formatted and encrypted using homomorphic encryption; and evaluating the garbled circuit from the crypto service provider with the summed data using oblivious transfer.

In another embodiment computing device for privacy-preserving ridge regression is provided. The computing device includes storage, memory, and a processor. The storage is for storing user data. The memory is for storing data for processing. The processor is configured to request a garbled circuit from a crypto service provider, collect data from multiple users that has been formatted and encrypted using homomorphic encryption, sum the data that has been formatted and encrypted using homomorphic encryption, and evaluate the garbled circuit from the crypto service provider with the summed data using oblivious transfer.

Objects and advantages will be realized and attained by means of the elements and couplings particularly pointed out in the claims. It is important to note that the embodiments disclosed are only examples of the many advantageous uses of the innovative teachings herein. It is to be understood that both the foregoing general description and the following detailed description are exemplary and explanatory and are not restrictive of the invention, as claimed. Moreover, some statements may apply to some inventive features but not to others. In general, unless otherwise indicated, singular elements may be in plural and vice versa with no loss of generality. In the drawings, like numerals refer to like parts through several views.

### BRIEF SUMMARY OF THE DRAWINGS

FIG. 1 depicts a block schematic diagram of a privacy-preserving ridge regression system according to an embodiment.

FIG. 2 depicts a block schematic diagram of a computing device according to an embodiment.

FIG. 3 depicts an exemplary garbled circuit according to an embodiment.

FIG. 4 depicts a high level flow diagram of a methodology for providing a privacy-preserving ridge regression according to the embodiment.

FIG. 5 depicts the operation of a first protocol for providing privacy-preserving ridge regression according to the embodiment.

FIG. 6 depicts the operation of a first protocol for providing privacy-preserving ridge regression according to the embodiment.

FIG. 7 depicts an exemplary embodiment of an algorithm for Cholesky decomposition according to the embodiment.

### DETAILED DESCRIPTION

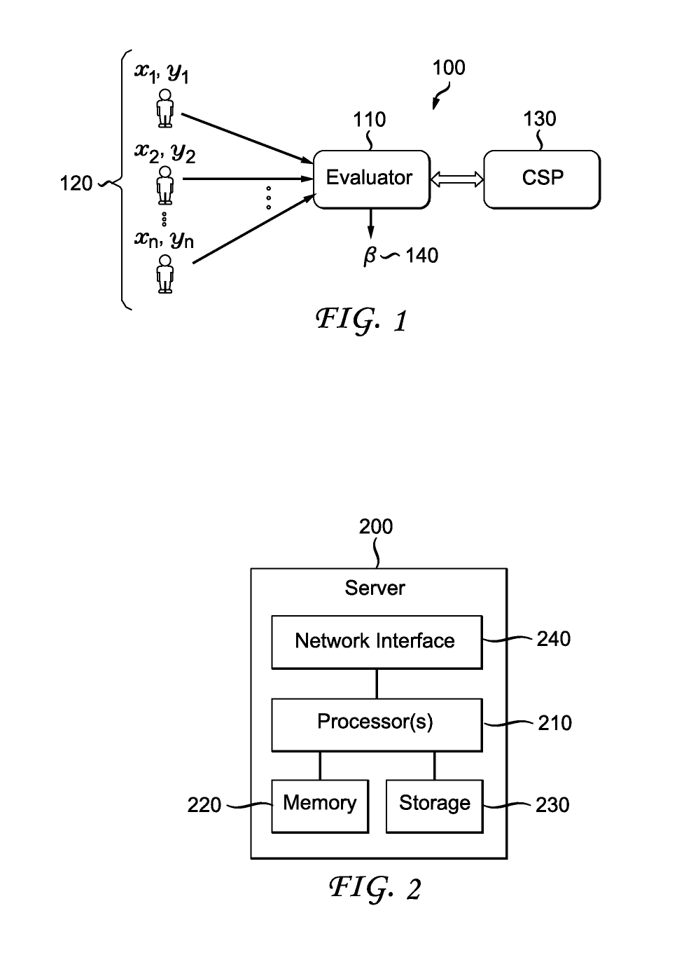

The focus of this disclosure is on a fundamental mechanism used in many learning algorithms, namely ridge regression. Given a large number of points in high dimension the regression algorithm produces a best-fit curve through these points. The goal is to perform the computation without exposing the user data or any other information about user data. This is achieved by using a system as shown in FIG. 1:

In FIG. 1, a block diagram of an embodiment of a system 100 for implementing privacy-preserving ridge regression is provided. The system includes an Evaluator 110, one or more users 120 and Crypto Service Provider (CSP) 130 which are in communication with each other. The Evaluator 110 is implemented on a computing device such as a server or personal computer (PC). The CSP 130 is similarly implemented on computing device such as a server or personal computer and is in communication with the Evaluator 110 over network, such as an Ethernet or Wi-Fi network. The one or more users 120 are in communication with the Evaluator 110 and CSP 130 via computing devices such as personal computers, tablets, smartphones, or the like.

Users 120 send encrypted data (from a PC, for example) to the Evaluator 110 (on a server, for example) which runs the learning algorithm. At certain points the Evaluator may interact with a Crypto Service Provider 130 (on another server) that is trusted not to collude with the Evaluator 110. The final outcome is the cleartext predictive model β 140.

FIG. 2 depicts an exemplary computing device 200, such as a server, PC, tablet, or smartphone, that can be used to implement the various methodology and system elements for privacy-protecting ridge regression. The computing device 200 includes one or more processors 210, memory 220, storage 230, and a network interface 240. Each of these elements will be discussed in more detail below.

The processor 210 controls the operation of the electronic server 200. The processor 200 runs the software that operates the server as well as provides the functionality of cold start recommendations. The processor 210 is connected to memory 220, storage 230, and network interface 240, and handles the transfer and processing of information between these elements. The processor 210 can be general processor or a processor dedicated for a specific functionality. In certain embodiments there can be multiple processors.

The memory 220 is where the instructions and data to be executed by the processor are stored. The memory 210 can include volatile memory (RAM), non-volatile memory (EEPROM), or other suitable media.

The storage 230 is where the data used and produced the processor in executing the cold storage recommendation methodology of the present is stored. The storage may be magnetic media (hard drive), optical media (CD/DVD-Rom), or flash based storage.

The network interface 240 handles the communication of the server 200 with other devices over a network. An example of a suitable network is an Ethernet network. Other types of suitable home networks will be apparent to one skilled in the art given the benefit of this disclosure.

It should be understood that the elements set forth in FIG. 2 are illustrative. The server 200 can include any number of elements and certain elements can provide part or all of the functionality of other elements. Other possible implementation will be apparent to on skilled in the art given the benefit of this disclosure.

### Settings and Threat Model

### A. Architecture and Entities

Referring back to FIG. 1, the system 100 is designed for many users 120 to contribute data to a central server called the Evaluator 110. The Evaluator 110 performs regression over the contributed data and produces a model, β 140, which can later be used for prediction or recommendation tasks. More specifically, each user i=1, : : : ; n has a private record comprising two variables xᵢε [symbol] ^{d} and yᵢε [symbol] , and the Evaluator wishes to compute βε [symbol] ^{d}—the model—such that yᵢ≅β^{T}xᵢ. The goal is to ensure that the Evaluator learns nothing about the user's records beyond what is revealed by β 140, the final result of the regression algorithm. To initialize the system a third party is needed, which is referred the herein as a “Crypto Service Provider,” that does most of its work offline.

More precisely, the parties in the system are the following, as shown in FIG. 1.
Users 120: each user i has private data xᵢ, yᵢ that it sends encrypted to the Evaluator 110.
Evaluator 110: runs a regression algorithm on the encrypted data and obtains the learned model β 140 in the clear.
Crypto Service Provider (CSP) 130: initializes the system 100 by giving setup parameters to the users 120 and the Evaluator 110.

The CSP 130 does most of its work offline long before the users 120 contribute their data to the Evaluator 110. In the most efficient design, the CSP 130 is also needed for a short one-round online step when the Evaluator 110 computes the model β 140.

### B. Threat Model

The goal is to ensure that the Evaluator 110 and the CSP 130 cannot learn anything about the data contributed by users 120 beyond what is revealed by the final results of the learning algorithm. In the case that the Evaluator 110 colludes with some of the users 120, the users 120 should learn nothing about the data contributed by other users 120 beyond what is revealed by the results of the learning algorithm.

In this example, it is assumed that it is the Evaluator's 110 best interest to produce a correct model β 140. Hence, this embodiment is not concerned with a malicious Evaluator 110 which is trying to corrupt the computation in the hope of producing an incorrect result. However, the Evaluator 110 is motivated to misbehave and learn information about private data contributed by the users 120 since this data can potentially be sold to other parties, e.g., advertisers. Therefore, even a malicious Evaluator 110 should be unable to learn anything about user data beyond what is revealed by the results of the learning algorithm. The basic protocol which is only secure against an honest-but-curious Evaluator is set forth herein.

Non-threats: The system is not designed to defend against the following attacks:
It is assumed that the Evaluator 110 and the CSP 130 do not collude. Each one may try to subvert the system as discussed above, but they do so independently. More precisely, when arguing security it is assumed that at most one of these two parties is malicious (this is an inherent requirement without which security cannot be achieved).
It is assumed that the setup works correctly, that is all users 120 obtain the correct public key from the CSP 130. This can be enforced in practice with appropriate use of Certificate Authorities.

### Background

### A. Learning a Linear Model

Briefly reviewing ridge regression, the algorithm that the evaluator 110 conducts in the system 110 to learn β 140. All results discussed below are classic, and can be found in most statistics and machine learning textbooks.

Linear Regression:

Given a set of n input variables xᵢε [symbol] ^{d}, and a set of output variables yᵢΣ [symbol] , the problem of learning a function ƒ: [symbol] ^{d}→ [symbol] such that yᵢ≅ƒ(xᵢ) is known as regression. For example, the input variables could be a person's age, weight, body mass index, etc., while the output can be their likelihood to contract a disease.

Learning such a function from real data has many interesting applications that makes regression ubiquitous in data mining, statistics, and machine learning. On one hand, the function itself can be used for prediction, i.e., to predict the output value y of a new input xε [symbol] ^{d}. Moreover, the structure of ƒ can aid in identifying how different inputs affect the output—establishing, e.g., that weight, rather than age, is more strongly correlated to a disease.

Linear regression is based on the premise that ƒ is well approximated by a linear map, i.e.,

γᵢ≅β^{T}xᵢ, iε[n]≡{1, . . . , n}

for some βε [symbol] ^{d}. Linear regression is one of the most widely used methods for inference and statistical analysis in the sciences. In addition, it is a fundamental building block for several more advanced methods in statistical analysis and machine learning, such as kernel methods. For example, learning a function that is a polynomial of degree 2 reduces to linear regression over xᵢₖxᵢₖ, for 1≦k, k′≦d; the same principle can be generalized to learn any function spanned by a finite set of basis functions.

As mentioned above, beyond its obvious uses for prediction, the vector β=(βₖ)_{k=1, . . , d} is interesting as it reveals how y depends on the input variables. In particular, the sign of a coefficient βₖ indicates either positive or negative correlation to the output, while the magnitude captures relative importance. To ensure these coefficients are comparable, but also for numerical stability, the inputs xᵢ are rescaled to the same, finite domain (e.g., [−1; 1]).

Computing the Coefficients:

To compute the vector βε [symbol] ^{d}, the latter is fit to the data by minimizing the following quadratic function over [symbol] ^{d}:

$$F ( β ) = {\sum }_{i = 1}^{n} {( {y}_{i} - {β}^{T} {x}_{i} )}^{2} + λ {‖ β ‖}_{2}^{2} . \qquad ( 1 )$$

The procedure of minimizing (1) is called ridge regression; the objective F(β) incorporates a penalty term λ∥β∥₂², which favors parsimonious solutions. Intuitively, for λ=0, minimizing (1) corresponds to solving a simple least squares problem. For positive λ>0, the term λ∥β∥₂² penalizes solutions with high norm: between two solutions that fit the data equally, one with fewer large coefficients is preferable. Recalling that the coefficients of β are indicators of how input affects output, this acts as a form of “Occam's razor”: simpler solutions, with few large coefficients, are preferable. Indeed, a λ>0 gives in practice better predictions over new inputs than the least squares solution based. Let yε [symbol] ⁿ be the vector of outputs and xε [symbol] ^{n×d} be a matrix comprising the input vectors, one in each row; i.e.,

$$y = {( {y}_{i} )}_{i = 1 , … , n} = ( \begin{matrix}{y}_{1} \\ {y}_{2} \\ ⋮ \\ {y}_{n}\end{matrix} )$$

$$and$$

$$X = {( {x}_{i}^{T} )}_{i = 1 , … , n} = ( \begin{matrix}{x}_{11} & {x}_{12} & … & {x}_{1 d} \\ {x}_{21} & {x}_{22} & … & {x}_{2 d} \\ ⋮ & ⋮ & & ⋮ \\ {x}_{n 1} & {x}_{n 2} & … & {x}_{nd}\end{matrix} ) .$$

The minimizer of (1) can be computed by solving the linear system

Aβ=b (2)

where A=X^{T}X+λI and b=X^{T}y. For λ>0, the matrix A is symmetric positive definite, and an efficient solution can be found using the Cholesky decomposition as outlined below.

### B. Yao's Garbled Circuits

In its basic version, Yao's protocol (a.k.a. garbled circuits) allows the two-party evaluation of a function ƒ(x₁; x₂) in the presence of semi-honest adversaries. The protocol is run between the input owners (aᵢ denotes the private input of user i). At the end of the protocol, the value of ƒ(a₁; a₂) is obtained but no party learns more than what is revealed from this output value.

The protocol goes as follows. The first party, called garbler, builds a “garbled” version of a circuit computing ƒ. The garbler then gives to the second party, called evaluator, the garbled circuit as well as the garbled-circuit input values that correspond to a₁ (and only those ones). The notation GI(a₁) is used to denote these input values. The garbler also provides the mapping between the garbled-circuit output values and the actual bit values. Upon receiving the circuit, the evaluator engages in a 1-out-of-2 oblivious transfer protocol with the garbler, playing the role of the chooser, so as to obliviously obtain the garbled-circuit input values corresponding to its private input a₂, GI(a₂). From GI(a₁) and GI(a₂), the evaluator can therefore calculate ƒ(a₁; a₂).

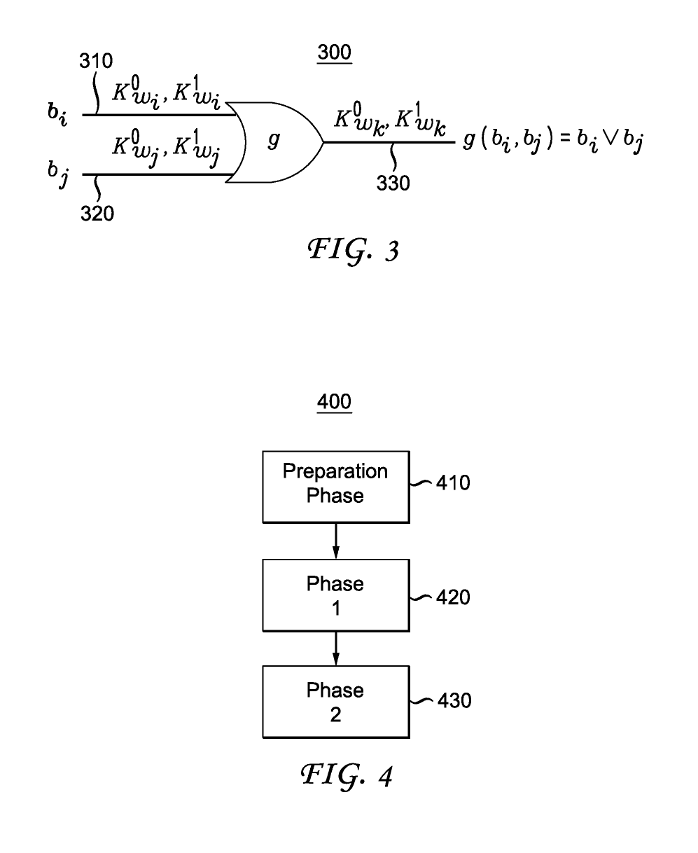

In more detail, the protocol evaluates the function ƒ through a Boolean circuit 300 as seen in FIG. 3. To each wire wᵢ 310,320 of the circuit, the garbler associates two random cryptographic keys, K_{w}_{ᵢ}⁰ and K_{w}_{ᵢ}¹, that respectively correspond to the bit-values bᵢ=0 and bᵢ=1. Next, for each binary gate g (e.g., an OR-gate) with input wires (wᵢ,wⱼ) 310, 320 and output wire wₖ 330, the garbler computes the four ciphertexts)

$${Enc}_{( {K}_{{w}_{i}}^{{b}_{i}} , {K}_{{w}_{j}}^{{b}_{j}} )} ( {K}_{{w}_{k}}^{g ( {b}_{i} , {b}_{j} )} ) for {b}_{i} , {b}_{j} ∈ \{ 0 , 1 \} .$$

The set of these four randomly ordered ciphertexts defines the garbled gate.

It is required that the symmetric encryption algorithm Enc, which is keyed by a pair of keys, has indistinguishable encryptions under chosen-plaintext attacks. It is also required that given the pair of keys (K_{w}_{ᵢ}^{b}^{ᵢ},K_{w}_{ⱼ}^{b}^{ⱼ}), the corresponding decryption process unambiguously recovers the value of K_{w}_{ₖ}^{g(b}^{ᵢ}^{,b}^{ⱼ}⁾ from the four ciphertexts constituting the garbled gate. It is worth noting that the knowledge of (K_{w}_{ᵢ}^{b}^{ᵢ},K_{w}_{ⱼ}^{b}^{ⱼ}) yields only the value of K_{w}_{ₖ}^{G(b}^{ᵢ}^{,b}^{ⱼ}⁾ and that no other output values can be recovered for this gate. So the evaluator can evaluate the entire garbled circuit gate-by-gate so that no additional information leaks about intermediate computations.

### Hybrid Approach

Recall that, in this setup, each input and output variable xᵢ, yᵢ, iε[n], is private, and held by a different user. The Evaluator 110 wishes to learn the β determining the linear relationship between the input and output variables, as obtained through ridge regression with a given λ>0.

As described in above, to obtain β, one needs the matrix Aε [symbol] ^{d×d} and the vector bΣ [symbol] ^{d}, as defined in equation (2). Once these values are obtained, the Evaluator 110 can solve the linear system of equation (2) and extract β. There are several ways to tackle this problem in a privacy-preserving fashion. One can for example rely on secret sharing or on fully homomorphic encryption. Presently, these techniques seem to be unsuitable for the present setting as they lead to significant (on-line) communication or computation overhead. Consequently, Yao's approach is explored, as outlined in above.

One simple way to use Yao's approach is to design a single circuit with inputs xᵢ, yᵢ, for iε[n], and λ>0, that computes the matrices A and b and subsequently solves the system Aβ=b. Such an approach has been used in the past for the computation of simple functions of inputs coming from multiple users, such the winner of an auction. Putting implementation issues aside (such as how to design a circuit that solves a linear system), a major shortcoming of such a solution is that the resulting garbled circuit depends on both the number of users n, as well as the dimension d of β and the input variables. In practical applications it is common that n is large, and can be in the order of millions of users. In contrast, d is relatively small, in the order of 10 s. It is therefore preferable to reduce, or even eliminate, the dependency of the garbled circuit in n, so as to get a scalable solution. To this end, the problem was reformulated as discussed below.

### A. Reformulating the Problem

Note that the matrix A and vector b can be computed in an iterative fashion, as follows. Assuming that each xᵢ and corresponding yᵢ are held by different users, each user i can locally compute the matrix Aᵢ=xᵢxᵢ^{T} and the vector bᵢ=yᵢxᵢ. It is then easily verified that summing the partial contributions yields:

$$A = {\sum }_{i = 1}^{n} {A}_{i} + λ I \\ and \\ b = {\sum }_{i = 1}^{n} {b}_{i} . \qquad ( 3 )$$

Equation (3) importantly shows that A and b are the result of a series of additions. The Evaluator's regression task can therefore be separated into two subtasks: (a) collecting the Aᵢ's and bᵢ's, to construct matrix A and vector b, and (b) using these to obtain β through the solution of the linear system (2).

Of course, the users cannot send their local shares, (Aᵢ; bᵢ), to the Evaluator in the clear. However, if the latter are encrypted using a public-key additive homomorphic encryption scheme, then the Evaluator 110 can reconstruct the encryptions of A and b from the encryptions of the (Aᵢ; bᵢ)'s. The remaining challenge is to solve equation (2), with the help of the CSP 130, without revealing (to the Evaluator 110 or the CSP 130) any additional information other than β; two distinct ways of doing so through the use of Yao's garbled circuits are described below.

More explicitly, let

[symbol]

ₚₖ:(Aᵢ;bᵢ)ε [symbol] [symbol] cᵢ= [symbol] ₚₖ(Aᵢ;bᵢ)

be a semantically secure encryption scheme indexed by a public key pk that takes on input a pair (Aᵢ; bᵢ) in the message space [symbol] and returns the encryption of (Aᵢ; bᵢ) under pk, cᵢ. Then it must hold for any pk and any two pairs (Aᵢ; bᵢ), (Aⱼ; bⱼ), that

[symbol]

ₚₖ(Aᵢ;bᵢ) [symbol] [symbol] ₚₖ(Aⱼ;bⱼ)= [symbol] ₚₖ(Aᵢ+Aⱼ;bᵢ+bⱼ)

for some public binary operator. Such an encryption scheme can be constructed from any semantically secure additive homomorphic encryption scheme by encrypting component-wise the entries of Aᵢ and bᵢ. Examples include Regev's scheme and Paillier's scheme.

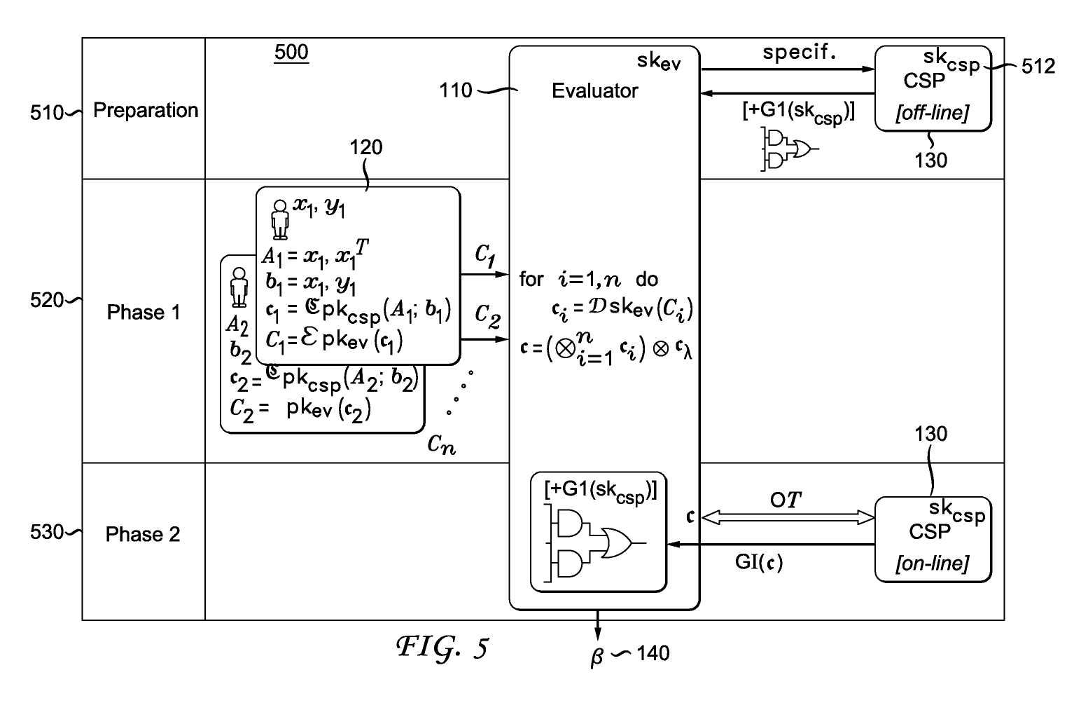

Protocols are now ready to be presented. A high-level flow chart 400 is provided in FIG. 4. The flow chart 400 includes a preparation phase 410, a first phase (Phase 1) 420, and a second phase (Phase 2) 430. The phase of aggregating the user shares is referred to as Phase 1 420, and note that the addition it involves depends linearly in n. The subsequent phase, which amounts to computing the solution to Equation (2) from the encrypted values of A and b, is referred to as Phase 2 430. Note that Phase 2 430 has no dependence on n. These phases will be discussed below in conjunction with specific protocols. Note that it is assumed below the existence of a circuit that can solve the system Aβ=b; how such a circuit can be implemented efficiently is discussed in herein.

### B. First Protocol

A high level depiction 500 of the operation of the first protocol can be seen in FIG. 5. The first protocol operates as follows. As set forth above, the first protocol comprises three phases: a preparation phase 510, Phase 1 520, and Phase 2 530. As will become apparent, only Phase 2 530 really requires an on-line treatment.

Preparation Phase (510).

The Evaluator 110 provides the specifications to the CSP 130, such as the dimension of the input variables (i.e., parameter d) and their value range. The CSP 130 prepares a Yao garbled circuit for the circuit described in Phase 2 530 and makes the garbled circuit available to the Evaluator 110. The CSP 130 also generates a public key pk_{csp} and a private key sk_{csp} for the homomorphic encryption scheme [symbol] , while the Evaluator 110 generates a public key pkₑᵥ and a private key skₑᵥ for an encryption scheme ε (that need not be homomorphic).

Phase 1 (520).

Each user i locally computes her partial matrix Aᵢ and vector bᵢ. These values are then encrypted using additive homomorphic encryption scheme [symbol] under the public encryption key pk_{csp} of the CSP 130; i.e.,

cᵢ= [symbol] ₚₖ_{_{csp}}(Aᵢ;bᵢ)

To prevent the CSP 130 from getting access to this value, the user i super-encrypts the value of cᵢ under the public encryption key pkₑᵥ of the Evaluator 110; i.e.,

Cᵢ=εₚₖ_{ₑᵥ}(cᵢ)

and sends Cᵢ to the Evaluator 110.
The Evaluator 110 computes c_{λ}= [symbol] ₚₖ_{_{csp}}(λI;0). It subsequently collects all received Cᵢ's and decrypts them using its private decryption key skₑᵥ to recover the cᵢ's; i.e.,

cᵢ= [symbol] ₛₖ_{ₑᵥ}(Cᵢ), for 1≦i≦n

It then aggregates the so-obtained values and gets:

$$c = ( {{⊗}^{n}}_{i = 1} {c}_{i} ) ⊗ {c}_{λ} = {p {k}_{csp}}_{} ( {\sum }_{i = 1}^{n} {A}_{i} + λ I ; {\sum }_{i = 1}^{n} {b}_{i} ) = {p {k}_{csp}}_{} ( A ; b ) . \qquad ( 4 )$$

Phase 2 (530).

The garbled circuit provided by the CSP 130 in the preparation phase 510 is a garbling of a circuit that takes as input GI(c) and does the following two steps:

1) decrypting c with sk_{csp} to recover A and b (here sk_{csp} is embedded in the garbled circuit); and
2) solving equation (2) and returning β.
   In this Phase 2 530, the Evaluator 110 need only to obtain the garbled-circuit input values corresponding to c; i.e., GI(c). These are obtained using a standard Oblivious Transfer (OT) between the Evaluator 110 and the CSP 130.

The above hybrid computation performs a decryption of the encrypted inputs within the garbled circuit. As this can be demanding, it is suggested to use for example Regev homomorphic encryption scheme as the building block for [symbol] since the Regev scheme has a very simple decryption circuit.

### C. Second Protocol

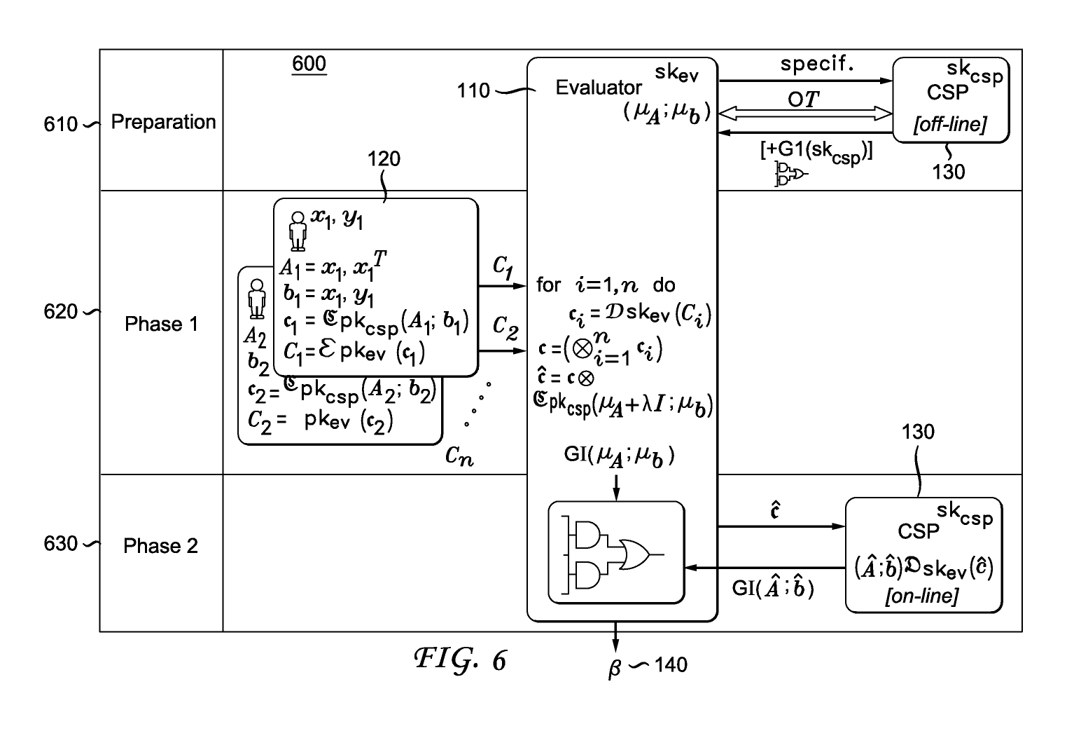

A high level depiction 600 of the operation of the second protocol can be seen in FIG. 6. The second protocol presents a modification that avoids decrypting (A; b) in the garbled circuit using random masks. Phase 1 610 remains broadly the same. Thus Phase 2 will be highlighted (and the corresponding preparation phase). The idea is to exploit the homomorphic property to obscure the inputs with an additive mask. Note that if (μ_{A};μ_{b}) denotes an element in [symbol] (namely, the message space of homomorphic encryption [symbol] ) then it follows from equation (4) that

c [symbol] [symbol] ₚₖ_{_{csp}}(μ_{A};μ_{b})= [symbol] ₚₖ_{_{csp}}(A+μ_{A};b+μ_{b})

Hence assume that the Evaluator 110 chooses a random mask (μ_{A};μ_{b}) in M, obscures c as above, and sends the resulting value to the CSP 130. Then, the CSP 130 can apply its decryption key and recover the masked values

Â=A+μ_{A} and \hat{b}=b+μ_{b}

As a consequence, one can apply the protocol of the previous section where the decryption is replaced by the removal of the mask. In more detail, it involves:

Preparation phase (610).

As before, the Evaluator 110 sets up the evaluation. The Evaluator 110 provides the specifications to the CSP 130 to build a garbled circuit supporting its evaluation. The CSP 130 prepares the circuit and makes it available to the Evaluator 110, and both generate public and private keys. The Evaluator 110 chooses a random mask (μ_{A}; μ_{b})ε [symbol] and engages in an Oblivious Transfer (OT) protocol with the CSP 130 to get the garbled-circuit input values corresponding to (μ_{A}; μ_{b}); i.e., GI μ_{A}; μ_{b}).

Phase 1 (620). This is similar to the first protocol. In addition, the Evaluator 110 masks c as

c=c [symbol] [symbol] ₚₖ_{_{csp}}(μ_{A};μ_{b})

Phase 2 (630).

The Evaluator 110 sends e to the CSP 130 that decrypts it to obtain (Â:\hat{b}) in the clear. The CSP 130 then sends the garbled input values GI(Â:\hat{b}) back to the Evaluator 110. The garbled circuit provided by the CSP 130 in the preparation phase is a garbling of a circuit that takes as input GI(Â:\hat{b}) and GI(μ_{A};μ_{b}) and does the following two steps:

1) subtracts the mask (μ_{A};μ_{b}) from (Â:\hat{b}) to recover A and b;

2) solves equation (2) and returns β.

The garbled circuit as well as the garbled-circuit input values corresponding to (μ_{A};μ_{b}), GI(μ_{A};μ_{b}), were obtained during the preparation phase 610. In this phase, the Evaluator 110 need only receive from the CSP 130 the garbled circuit input values corresponding to (Â;\hat{b}), GI(Â:\hat{b}). Note that there is no Oblivious Transfer (OT) in this phase.

For this second realization, the decryption is not executed as part of the circuit. Therefore one is not restricted to selecting a homomorphic encryption scheme that can be efficiently implemented as a circuit. Instead of Regev's scheme, it is suggested to use Paillier's scheme or its generalization by Damgard and Junk as the building block for These schemes have a shorter ciphertext expansion than Regev and require smaller keys.

### D. Third Protocol

For some applications, a related idea applies when the homomorphic encryption scheme has only a partial homomorphic property. This notion is made explicit in the next definition.

Definition 1:

A partially homomorphic encryption scheme is an encryption scheme such that it is possible to add (if the partial homomorphism is additive) or to multiply (if the partial homomorphism is multiplicative) a constant to an encrypted plaintext without needing the private encryption key.

Here are some examples.
Let [symbol] ₚ denote a prime field and let G= [symbol] g [symbol] be a cyclic subgroup of the multiplicative group [symbol] *ₚ, generated by g. Let q denote the order of G. For plain ElGamal encryption, the message space is [symbol] =G. The public encryption key is y=g^{x} while the private key is x. The encryption of a message m in [symbol] is given by (R; c) with R=g^{r} and c=my^{r} for some random rε [symbol] /q [symbol] Plaintext m is then recovered using secret key x as m=c/R^{x}.
The above system is partially homomorphic with respect to the multiplication in [symbol] *ₚ: For any constant Kε [symbol] , C′=(R; Kc) is the encryption of message m′=Km.
The so-called hashed ElGamal cryptosystem requires in addition an hash function H, mapping group elements from G to [symbol] ₂^{k}, for some parameter k. The message space is [symbol] = [symbol] ₂^{k}. The key generation is as for plain ElGamal. The encryption of a message mε [symbol] is given by (R; c) with R=g^{r} and c=m+H(y^{r}) for some random rε [symbol] /q [symbol] . Plaintext m is then recovered using secret key x as m=c+H(R). Note that ‘+’ corresponds to the addition in [symbol] ₂^{k} (i.e., it can equivalently be seen as an XOR on k-bit strings).
The above system is partially homomorphic with respect to the XOR: For any constant Kε [symbol] , C′=(R;K+c) is the encryption of message m′=K+m.

For the sake of non-limiting example, suppose now that c is the encryption of (A; b) under a partially homomorphic encryption scheme, say [symbol] , then if (μ_{A};μ_{b}) denotes an element in [symbol] (namely, the message space of partially homomorphic encryption [symbol] ) then it follows from equation (4) that

c⊕ [symbol] ₚₖ_{_{csp}}(μ_{A};μ_{b})= [symbol] ₚₖ_{_{csp}}(A+μ_{A};b+μ_{b})

for some operator ⊕. (In the above description, the homomorphism is noted additively; the same holds true for a multiplicatively written homomorphism.)

Hence, assume that the Evaluator 110 chooses a random mask (μ_{A};μ_{b}) in [symbol] , obscures c as above, and sends the resulting value to the CSP 130. Then, the CSP 130 can apply its decryption key and recover the masked values

Â=A+μ_{A} and \hat{b}=b+μ_{b}

As a consequence, the protocol of the previous section can be applied where the decryption is replaced by the removal of the mask.

Finally, note that the trick of using a mask as per the second or third protocol is not limited to the case of ridge regression. It can be used in any application combining in a hybrid way homomorphic encryption (respectively partially homomorphic encryption) with garbled circuits.

### E. Discussion

The proposed protocols have several strengths that make them efficient and practical in real-world scenarios. First, there is no need for users to stay on-line during the process. Since Phase 1 420 is incremental, each user can submit their encrypted inputs, and leave the system.

Furthermore, the system 100 can be easily applied to performing ridge regression multiple times. Assuming that the Evaluator 110 wishes to perform l estimations, it can retrieve l garbled circuits from the CSP 130 during the preparation phase 410. Multiple estimations can be used to accommodate the arrival of new users 120. In particular, since the public keys are long-lived, they do not need to be refreshed too often, meaning that when new users submit more pairs (Aᵢ; bᵢ) to the Evaluator 110, the latter can sum them with the prior values and compute an updated β. Although this process requires utilizing a new garbled circuit, the users that have already submitted their inputs do not need to resubmit them.

Finally, the amount of required communications is significantly smaller than in a secret sharing scheme, and only the Evaluator 110 and the CSP 130 communicate using Oblivious Transfer (OT). Note also that, rather than using the public key encryption scheme ε in Phase 1 420, the users can use any means to establish a secure communication with the Evaluator 110, such as, e.g., SSL.

### F. Further Optimizations

Recall that the matrix A is in [symbol] ^{d×d} and the vector b is in [symbol] ^{d}. Hence letting k denote the bit-size used to encode real numbers, the matrix A and vector b respectively need d²k bits and dk bits for their representation. The second protocol requires a random mask (μ_{A};μ_{b}) in [symbol] . Suppose that the homomorphic encryption scheme [symbol] was built on top of Paillier's scheme where every entry of A and of b is individually Paillier encrypted. In this case the message space [symbol] of [symbol] is composed of (d²+d) elements in [symbol] /N [symbol] for some RSA modulus N. But as those elements are k-bit values there is no need to draw the corresponding masking values in the whole range [symbol] /N [symbol] . Any (k+1)-bit values for some (relatively short) security length l will do, as long as they statistically hide the corresponding entry. In practice, this leads to fewer Oblivious Transfers in the preparation phase and to a smaller garbled circuit.

Another way to improve the efficiency is via a standard batching technique, that is packing multiple plaintext entries of A and b into a single Paillier ciphertext. For example, packing 20 plaintext values into a single Paillier ciphertext (separated by sufficiently many 0's) will reduce the running time of Phase 1 by a factor of 20.

### Implementation

To assess the practicality of the privacy-preserving system, the system was implemented and tested on both synthetic and real datasets. The second protocol proposed above was implemented, as it does not require decryption within the garbled circuit, and allows for the use of homomorphic encryption that is efficient for Phase 1 (that only involves summation).

### A. Phase 1 Implementation

As discussed above, for homomorphic encryption Paillier's scheme was use with a 1024 bits long modulus, which corresponds to 80-bits security level. To speed up Phase 1, batching was also implemented as outlined in above. Given n users that contribute their inputs, the number of elements that can be batched into one Paillier ciphertext of 1024 bits is 1024=(b+log₂ n), where b is the total number of bits for representing numbers. As discussed later, b is determined as a function of the desired accuracy, thus in this experiment, between 15 and 30 elements were batched.

### B. Circuit Garbling Framework

The system was built on top of FastGC, a Java-based open-source framework that enables developers to define arbitrary circuits using elementary XOR, OR and AND gates. Once the circuits are constructed, the framework handles garbling, oblivious transfer and the complete evaluation of the garbled circuit. FastGC includes several optimizations. First, the communication and computation cost for XOR gates in the circuit is significantly reduced using the “free XOR” technique. Second, using the garbled-row reduction technique, FastGC reduces the communication cost for k-fan-in non-XOR gates by 1=2^{k}, which gives a 25% communication saving, since only 2-fan-in gates are defined in the framework. Third, FastGC implements the OT extension which can execute a practically unlimited number of transfers at the cost of k OTs and several symmetric-key operations per additional OT. Finally, the last optimization is the succinct “addition of 3 bits” circuit, which defines a circuit with four XOR gates (all of which are “free” in terms of communication and computation) and just one AND gate. FastGC enables the garbling and evaluation to take place concurrently. More specifically, the CSP 130 transmits the garbled tables to the Evaluator 110 as they are produced in the order defined by circuit structure. The Evaluator 110 then determines which gate to evaluate next based on the available output values and tables. Once a gate was evaluated its corresponding table is immediately discarded. This amounts to the same computation and communication costs as pre-computing all garbled circuits off-line, but brings memory consumption to a constant.

### C. Solving a Linear System in a Circuit

One of the main challenges of the present approach is designing a circuit that solves the linear system Aβ=b, as defined in equation (2). When implementing a function as a garbled circuit, it is preferable to use operations that are data-agnostic, i.e., whose execution path does not depend on the input. For example, as inputs are garbled, the Evaluator 110 needs to execute all possible paths of an if-then-else statement, which leads to an exponential growth of both the circuit size and the execution time in the presence of nested conditional statements. This renders impractical any of the traditional algorithms for solving linear systems that require pivoting, such as, e.g., Gaussian elimination.

For the sake of simplicity, this system implemented the standard Cholesky algorithm presented below. Note, however, that its complexity can be further reduced to the same complexity as block-wise inversion using similar techniques.

There are several possible decomposition methods for solving linear systems. Cholesky decomposition is a data-agnostic method for solving a linear system that is applicable only when the matrix A is symmetric positive definite. The main advantage of Cholesky is that it is numerically robust without the need for pivoting. In particular, it is well suited for fixed point number representations.

Since A=λI+Σᵢⁿk xᵢxᵢ^{T} is indeed a positive definite matrix for λ>0, Cholesky was chosen as the method of solving Aβ=b in this implementation.
The main steps of Cholesky decomposition are briefly outlined below. The algorithm constructs a lower-triangular matrix L such that A=L^{T}L: Solving the system Aβ=b then reduces to solving the following two systems:

L^{T}y=b; and

Lβ=y

Since matrices L and LT are triangular, these systems can be solved easily using back substitution. Moreover, because matrix A is positive definite, matrix L necessarily has nonzero values on the diagonal, so no pivoting is necessary.

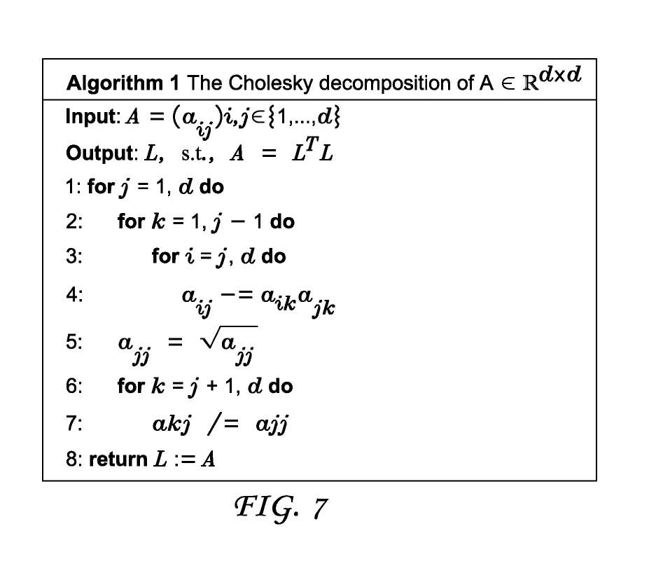

The decomposition A=L^{T}L is described in Algorithm 1 shown in FIG. 7. It involves Θ(d³) additions, Θ(d³) multiplications, Θ(d²) divisions and Θ(d) square root operations. Moreover, the solution of the two systems above through backwards elimination involves Θ(d²) additions, Θ(d²) multiplications and Θ(d) divisions. The implementation of these operations as circuits are discussed below.

### D. Representing Real Numbers

In order to solve the linear system (2), it is necessary to accurately represent real numbers in a binary form. Two possible approaches for representing real Numbers were considered: floating point and fixed point. Floating point representation of a real number a is given by formula:

[a]=[m;p]; where a≈1·m·2^{p}

Floating point representation has the advantage of accommodating numbers of practically arbitrary magnitude. However, elementary operations on floating point representations, such as addition, are difficult to implement in a data-agnostic way. Most importantly, using Cholesky warrants using fixed point representation, which is significantly simpler to implement. Given a real number a, its fixed point representation is given by:

[a]=[a·2^{p}], where the exponent p is fixed.

As discussed herein, many of the operations needed to be performed can be implemented in a data-agnostic fashion over fixed point numbers. As such, the circuits generated for fixed point representation are much smaller. Moreover, recall that the input variables of ridge regression xi are typically resealed the same domain (between −1 and 1) to ensure that the coefficients of β are comparable, and for numerical stability. In such a setup, it is known that Cholesky decomposition can be performed on A with fixed point numbers without leading to overflows. Moreover, given bounds on yᵢ and the condition number of the matrix A, the bits necessary to prevent overflows can be computed while solving the last two triangular systems in the method. Thus the system was implemented using fixed point representations. The number of bits p for the fractional part can be selected as a system parameter, and creates a trade-off between the accuracy of the system and size of the generated circuits. However, selecting p can be done in a principled way based on the desired accuracy. Negative numbers are represented using the standard two's complement representation.

The various embodiments disclosed herein can be implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

All examples and conditional language recited herein are intended for pedagogical purposes to aid the reader in understanding the principles of the embodiments and the concepts contributed by the inventor to furthering the art, and are to be construed as being without limitation to such specifically recited examples and conditions. Moreover, all statements herein reciting principles, aspects, and varies embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

1. A method for providing privacy-preserving ridge regression, the method comprising:
requesting a garbled circuit from a crypto service provider;
collecting data from multiple users that has been formatted and encrypted using homomorphic encryption;
summing the data that has been formatted and encrypted using homomorphic encryption; and
evaluating the garbled circuit from the crypto service provider with the summed data using oblivious transfer.

2. The method of claim 1, wherein the step of requesting a garbled circuit from a crypto service provider comprises:
providing a dimension of the input variables for the garbled circuit; and
providing the value range of the input variables.

3. The method of claim 1 wherein an evaluator implemented on a computing device performs the method.

4. The method of claim 3 wherein the crypto service provider is implemented on a computing device remote from the computing device the evaluator is implemented on.

5. The method of claim 1 further comprising the step of providing an encryption key for encrypting the data from multiple users.

6. The method of claim 5 wherein the data from multiple users is further encrypted with an encryption key provided by the crypto service provider.

7. The method of claim 1 wherein the step of evaluating the garbled circuit further comprises:
decrypting the summed data; and
solving the ridge regression equation embodied by the garbled circuit.

8. The method of claim 1 wherein the step of collecting data from multiple users comprises receiving data sent from each of the multiple users via a computing device.

9. A computing device for providing privacy-preserving ridge regression, the computer device comprising:
a storage for storing user data;
a memory for storing data for processing; and
a processor configured to request a garbled circuit from a crypto service provider, collect data from multiple users that has been formatted and encrypted using homomorphic encryption, sum the data that has been formatted and encrypted using homomorphic encryption, and evaluate the garbled circuit from the crypto service provider with the summed data using oblivious transfer.

10. The computing device of claim 9 further comprising a network connection for connecting to a network.

11. The computing device of claim 9 wherein the crypto service provider is implemented on a separate computing device.

12. The computing device of claim 9 wherein the step of requesting a garbled circuit from a crypto service provider comprises:
providing a dimension of the input variables for the garbled circuit; and
providing the value range of the input variables.

13. The computing device of claim 9 wherein the step of evaluating the garbled circuit further comprises:
decrypting the summed data; and
solving the ridge regression equation embodied by the garbled circuit.

14. The computing device of claim 9, wherein the data from multiple users is encrypted with an encryption key provided by the crypto service provider and encrypted with and encryption key by the computing device.

15. A machine readable medium containing instructions that when executed perform the steps comprising:
requesting a garbled circuit from a crypto service provider;
collecting data from multiple users that has been formatted and encrypted using homomorphic encryption;
summing the data that has been formatted and encrypted using homomorphic encryption; and
evaluating the garbled circuit from the crypto service provider with the summed data using oblivious transfer.
